(19) United States
(12) Patent Application Publication
(10) Pub. No.: US 2012/0154914 A1
(43) Pub. Date: Jun. 21, 2012

(54) INTERFERENCE FILTER ASSEMBLY

(75) Inventors: Chihiro Moriguchi, Nisshin-city (JP); Hiroshi Ando, Nagoya-city (JP); Katsuhiro Morikawa, Nagoya-city (JP)

(73) Assignee: DENSO CORPORATION, Kariya-city (JP)

(21) Appl. No.: 13/325,146

(22) Filed: Dec. 14, 2011

(30) Foreign Application Priority Data
Dec. 16, 2010 (JP) 2010-280812

(51) Int. Cl. G02B 5/28

(52) U.S. Cl. 359/577

(57) ABSTRACT

An interference filter assembly includes a condenser lens, a collimating lens, an interference filter, and an imaging device, which are arranged in a direction of light travel. The collimating lens is spaced from the condenser lens by a predetermined distance that corresponds to one of a focal length of the condenser lens and a focal length of the collimating lens. The collimating lens is provided by a single lens and applies a collimated light toward the imaging device through the interference filter in the direction of light travel. The collimating lens has a first surface adjacent to the condenser lens and a second surface adjacent to the interference filter. The first surface is a curved surface that is convex toward the condenser lens and a circular hyperboloid. The second surface is a plane surface and outputs the collimated light to the interference filter.

### CROSS REFERENCE TO RELATED APPLICATION

This application is based on Japanese Patent Application No. 2010-280812 filed on Dec. 16, 2010, the disclosure of which is incorporated herein by reference.

### FIELD OF THE INVENTION

The present invention relates to an interference filter assembly in which a condenser lens, a collimating lens, and an interference filter are arranged in a direction of light travel.

### BACKGROUND OF THE INVENTION

For example, JP07-49417A describes an interference filter assembly including two microlenses and an interference filter disposed between the two microlenses. One of the microlenses, which is in front of the interference filter, is located at a focal position of a focusing system. The other of the microlenses, which is behind the interference filter, is located at a position to form an image to a detecting element array. The front microlens collimates light focused in the focusing system. The interference filter transmits the collimated light outputted from the front microlens. The rear microlens focuses the collimated light on the detecting element array.

A microlens is formed by coupling multiple lenses. Therefore, if light enters the boundary of the lenses, the light will be scattered. As a result, rays of light which are not parallel will be generated from the front microlens.

The interference filter has a function of transmitting a light in a predetermined wavelength band. However, if the light does not perpendicularly enter the interference filter due to the scatter, it is difficult to output the light in the desired wavelength band.

### SUMMARY OF THE INVENTION

The present invention is made in view of the foregoing matter, and it is an object of the present invention to provide an enhanced interference filter assembly.

According to an aspect, an interference filter assembly includes a condenser lens, a collimating lens, an interference filter, and an imaging device, which are arranged in a direction of light travel. The collimating lens is spaced from the condenser lens by a predetermined distance that corresponds to one of a focal length of the condenser lens and a focal length of the collimating lens. The collimating lens is provided by a single lens and applies a collimated light to the imaging device through the interference filter in the direction of light travel. The collimating lens has a first surface adjacent to the condenser lens and a second surface adjacent to the interference filter. The first surface is a curved surface that is convex toward the condenser lens and is a circular hyperboloid. The second surface is a plane surface and outputs the collimated light to the interference filter.

In a state where the condenser lens and the collimating lens are spaced from each other by the predetermined distance, when a light focused in the condenser lens enters the circular hyperboloid of the collimating lens, a collimated light is generated without being affected by a spherical aberration of the condenser lens. Therefore, it is less likely that rays of light other than the collimated light will enter the interference filter. Accordingly, it is less likely that the function of the interference filter will be seemingly degraded, and hence a function of the interference filter assembly enhances.

### BRIEF DESCRIPTION OF THE DRAWINGS

Other objects, features and advantages of the present invention will become more apparent from the following detailed description made with reference to the accompanying drawings, in which like parts are designated by like reference numbers and in which:

FIG. 1 is a schematic cross-sectional view of an interference filter assembly according to an embodiment; and

FIG. 2 is a cross-sectional view of a collimating lens for explaining a circular hyperboloid according to the embodiment.

### DETAILED DESCRIPTION OF EXEMPLARY EMBODIMENT

Hereinafter, an exemplary embodiment will be described with reference to the drawings.

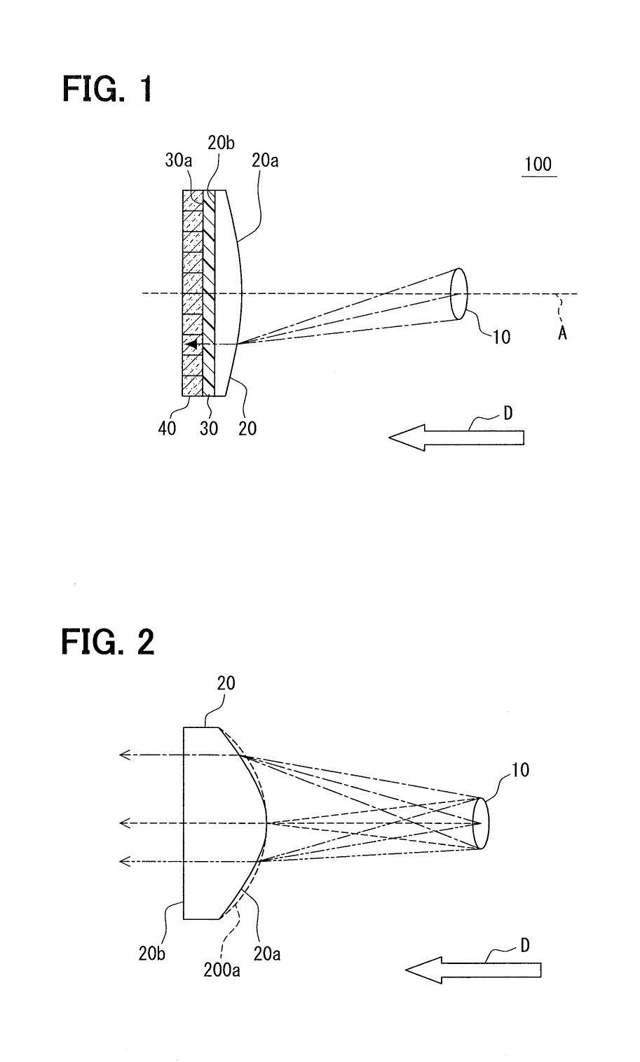

Referring to FIG. 1, an interference filter assembly 100 is exemplarily employed to apply collimated light in a predetermined wavelength band to an imaging device.

The interference filter assembly 100 includes a condenser lens 10 for focusing light, a collimating lens 20 for generating collimated light, an interference filter 30 selectively transmitting a light in a predetermined wavelength band, and an imaging device 40.

In FIG. 1, a dotted line A denotes an optical axis. Also, a dashed-line illustrates rays of light entering the imaging device 40 through the condenser lens 10, the collimating lens 20 and the interference filter 30. In FIG. 2, rays of light that enter the collimating lens 20 from the condenser lens 10 are illustrated by a dashed line, a dashed-chain line, and a double dashed-chain line. A surface 20a of the collimating lens 20 is not a spherical surface. In FIG. 2, therefore, a spherical surface 200a is illustrated by a dashed-line as a comparative example for clarifying that the surface 20a is not the spherical surface. Further, a direction from the condenser lens 10 to the collimating lens 20 is referred to as a direction of light travel. An arrow D denotes the direction of light travel.

The condenser lens 10, the collimating lens 20, the interference filter 30 are arranged in this order in the direction D of light travel. A distance between the condenser lens 10 and the collimating lens 20 is equal to a focal length of the collimating lens 20 or a focal length of the condenser lens 10.

As shown in FIG. 2, rays of light focused through the condenser lens 10 is refracted at the surface 20a of the collimating lens 20 to be a collimated light. The collimated light is radiated to the interference filter 30. In the interference filter 30, a light in a predetermined wavelength band is selected. The selected light is applied to the imaging device 40, which is disposed behind the interference filter 30.

The condenser lens 10 focuses rays of light to form an image at the focal position. In the present embodiment, for example, the condenser lens 10 is a wide-angle lens where both an incident surface to which light enters and an output surface from which the light comes out are convex.

The collimating lens 20 is a plano-convex lens where the surface 20a facing the condenser lens 10 is a curved surface and the surface 20b facing the interference filter 30 is a plane surface. Further, the collimating lens 20 is provided by a single lens (e.g., a single piece of lens). For example, the distance between the condenser lens 10 and the collimating lens 20 coincides with the focal length of the collimating lens 20, and the focal point of the collimating lens 20 coincides with a center (center of gravity) of the condenser lens 10. The surface 20a of the collimating lens 20 will be described later in detail.

The interference filter 30 restricts optical noise caused by ambient light from entering the imaging device 40. The interference filter 30 is configured to transmit only a light in a predetermined wavelength band and blocks the other. The interference filter 30 is disposed on the surface 20b of the collimating lens 20.

When receiving the light in the predetermined range of wavelength from the interference filter 30, the imaging device 40 converts the light into an electric signal. For example, the imaging device includes multiple imaging elements arrayed on the surface 30a of the interference filter 30 on a side opposite to the collimating lens 20.

As shown in FIG. 2, the surface 20a of the collimating lens 20 is an aspheric surface. Specifically, the surface 20a is a circular hyperboloid (hyperboloid of revolution), and is approximately calculated by the following equation:

$$z ( r ) = \frac{{cr}^{2}}{1 + \sqrt{1 - ( 1 + k ) {c}^{2} {r}^{2}}}$$

where z is a variable in the direction D of light travel, r is a variable in a direction perpendicular to the direction D of light travel, c is a radius of curvature, and k is a conic coefficient. It is to be noted that the conic coefficient k is a value smaller than −1.

In a simulation result, it was appreciated that, when receiving the light focused by the condenser lens 10 through the surface 20a, the collimating lens 20 generates the collimated light without being affected by a spherical aberration of the condenser lens 10.

In such a case, therefore, it is less likely that rays of light other than the collimated light will enter the interference filter 30 as the structure where the collimating lens is provided by the microlens. Accordingly, it is less likely that the function of the interference filter 30 will be seemingly degraded.

The collimating lens 20 is the plano-convex lens. Since the plano-convex lens is formed by polishing a single lens, a manufacturing cost reduces, as compared with the microlens provided by coupling the multiple lenses.

As described above, the collimating lens 20 of the present embodiment outputs the collimated light without being affected by the spherical aberration of the condenser lens 10. Therefore, the condenser lens 10 can be suitably selected without considering the spherical aberration.

In the present embodiment, for example, the interference filter 30 is disposed on the surface 20b of the collimating lens 20. In such a structure, the size of the interference filter assembly 100 is reduced, as compared with a structure where the interference filter 30 is spaced from the collimating lens 20.

In the present embodiment, for example, the imaging device 40 is disposed on the surface 30a of the interference filter 30. In such a structure, the size of the interference filter assembly 100 is reduced, as compared with a structure where the imaging device 40 is spaced from the interference filter 30.

The exemplary embodiment is described hereinabove. However, the present invention is not limited to the above described exemplary embodiment, but may be implemented in various other ways without departing from the spirit of the invention.

In the above described exemplary embodiment, the interference filter 30 is exemplarily disposed on the surface 20b of the collimating lens 20. Alternatively, the interference filter 30 may be spaced from the collimating lens 20.

In the above described exemplary embodiment, the imaging device 40 is exemplarily disposed on the surface 30a of the interference filter 30. Alternatively, the imaging device 40 may be spaced from the interference filter 30.

In the above described exemplary embodiment, the distance between the condenser lens 10 and the collimating lens 20 is exemplarily equal to the focal length of the collimating lens 20. However, the distance between the condenser lens 10 and the collimating lens 20 is not limited to the focal length of the collimating lens 20.

For example, the distance between the condenser lens 10 and the collimating lens 20 may be equal to the focal length of the condenser lens 10. In such a case, it is preferable that the focal point of the condenser lens 10 is located on the surface 20a of the collimating lens 20.

In a case where the focal length of the condenser lens 10 and the focal length of the collimating lens 20 are equal to each other, the collimating lens 20 is located at the focal position of the condenser lens 10 and the condenser lens 10 is located on the focal position of the collimating lens 20.

In the above described exemplary embodiment, both of the incident surface and the output surface of the condenser lens 10 are convex. However, the shape of the condenser lens 10 is not limited to the above described example. The condenser lens 10 may have any other shapes as long as light is focused and an image is formed at the focal position. For example, the condenser lens 10 may be a plano-convex lens where only the incident surface is convex, or a coupling lens of plano-convex lenses.

Additional advantages and modifications will readily occur to those skilled in the art. The invention in its broader term is therefore not limited to the specific details, representative apparatus, and illustrative examples shown and described.

What is claimed is:

1. An interference filter assembly comprising:
a condenser lens;
a collimating lens;
an interference filter; and
an imaging device, wherein
the condenser lens, the collimating lens, the interference filter and the imaging device are arranged in a direction of light travel,
the collimating lens is spaced from the condenser lens by a predetermined distance that corresponds to one of a focal length of the condenser lens and a focal length of the collimating lens,
the collimating lens is provided by a single lens, and applies a collimated light toward the imaging device through the interference filter in the direction of light travel,
the collimating lens has a first surface adjacent to the condenser lens and a second surface adjacent to the interference filter,
the first surface is a curved surface that is convex toward the condenser lens and is a circular hyperboloid, and
the second surface is a plane surface and outputs the collimated light to the interference filter.

2. The interference filter assembly according to claim 1, wherein the circular hyperboloid is approximated by a following equation:
$$z ( r ) = \frac{{cr}^{2}}{1 + \sqrt{1 - ( 1 + k ) {c}^{2} {r}^{2}}}$$
wherein z is a variable in the direction of light travel, r is a variable in a direction perpendicular to the direction of light travel, c is a radius of curvature, and k is a conic coefficient that is smaller than −1.

3. The interference filter assembly according to claim 1, wherein the interference filter is disposed on the second surface of the collimating lens.

4. The interference filter assembly according to claim 1, wherein the imaging device includes a plurality of imaging elements and is disposed on a surface of the interference filter.

5. The interference filter assembly according to claim 2, wherein the interference filter is disposed on the second surface of the collimating lens.

6. The interference filter assembly according to claim 5, wherein the imaging device includes a plurality of imaging elements and is disposed on a surface of the interference filter.
